(19) United States
(12) Patent Application Publication
(10) Pub. No.: US 2026/0316955 A1
(43) Pub. Date: Oct. 15, 2026

(54) Spatial Monitoring System for Optimizing Aircraft Loading

(71) Applicant: The Boeing Company, Arlington, VA (US)

(72) Inventors: Nathan W. Sieben, Bothell, WA (US); Nathan D. Hiller, Irvine, CA (US)

(21) Appl. No.: 19/175,137

(22) Filed: Apr. 10, 2025

(51) Int. Cl. B64D 45/00; B64D 11/00; B64D 47/08; G06V 20/52

(52) U.S. Cl. CPC B64D 45/0005; B64D 47/08; G06V 20/52; B64D 11/003

(57) ABSTRACT

A method for aircraft management. Image data is received for areas of an aircraft that include deployment zones for overhead bins in the aircraft. The deployment zones are physical volumes that each overhead bin moves through and occupies as the overhead bin is opened. At least one of an opening or a closing of the overhead bins is identified using the image data to form overhead bin usage data. The overhead bin usage data is stored in a data collection. The data collection is analyzed to determine a number of actions to perform for the aircraft.

### BACKGROUND INFORMATION

### 1. Field

The present disclosure relates generally to aircraft, and in particular to spatial monitoring in aircraft.

### 2. Background

Overhead bins are present in the passenger cabin. These bands can be used for storing carry-on luggage can items. Further, overhead bins are used to prevent these items from becoming hazards during turbulence or other situations. The use of overhead bins can also increase boarding and deplaning efficiency as compared to having checked bags.

The flight deck of a commercial airplane is designed to provide an ergonomic and secure work area for pilots and other flight crew that may be stationed in the flight deck. Space is tight within flight deck. The seats in the flight deck are adjustable and mounted on rails. In some cases, a pilot seat may obstruct or partially obstruct the movement of the flight deck door when this door is opened. As a result, a seat in the flight deck may need to be moved or adjusted to allow for ease of movement in opening the flight deck door to allow a pilot or other crew member to enter or exit.

### SUMMARY

An embodiment of the present disclosure provides an aircraft management system comprising a camera system in an aircraft; deployment zones for overhead bins in the aircraft; a computer system; and a bin analyzer in the computer system. The deployment zones are physical volumes that each overhead bin moves through and occupies as the overhead bin is opened. The overhead bin analyzer performs operations. The overhead bin analyzer receives image data from the camera system. The image data is for areas of the aircraft that include the deployment zones. The overhead bin analyzer determines whether a number of open overhead bins are present in the deployment zones using the image data. The overhead bin analyzer generates an indication of the number of open overhead bins in response to the number of open overhead bins being open during a phase of flight in which the overhead bins are to be closed.

Another embodiment of the present disclosure provides an aircraft management system comprising a computer system; and an overhead bin analyzer in the computer system. The overhead bin analyzer performs operations. The overhead bin analyzer receives image data from a camera system in an aircraft. The image data is for areas of the aircraft that include deployment zones for overhead bins in the aircraft. The deployment zones are physical volumes that each overhead bin moves through and occupies as the overhead bin is opened. The overhead bin analyzer identifies at least one of an opening or a closing of the overhead bins using the image data to form overhead bin usage data. The overhead bin analyzer stores the overhead bin usage data in a data collection. The overhead bin analyzer analyzes the data collection to determine a number of actions to perform for the aircraft.

Yet another embodiment of the present disclosure provides a method for open overhead bin indication. Image data is received from a camera system in an aircraft. The image data is for areas of the aircraft that include deployment zones for overhead bins in the aircraft. The deployment zones are physical volumes that each overhead bin moves through and occupies as the overhead bin is opened. A determination is made as to whether a number of open overhead bins are present in the deployment zones using the image data. An indication of the number of open overhead bins is generated in response to the number of overhead bins being open during a phase of flight in which the overhead bins are to be closed.

Still another embodiment of the present disclosure provides a method for aircraft management. Image data is received for areas of an aircraft that include deployment zones for overhead bins in the aircraft. The deployment zones are physical volumes that each overhead bin moves through and occupies as the overhead bin is opened. At least one of an opening or a closing of the overhead bins is identified using the image data to form overhead bin usage data. The overhead bin usage data is stored in a data collection. The data collection is analyzed to determine a number of actions to perform for the aircraft.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a cutaway view of an aircraft in accordance with an illustrative embodiment;

FIG. 2 is an illustration of a block diagram of an aircraft environment in accordance with an illustrative embodiment;

FIG. 3 is an illustration of a flight deck of an aircraft containing a swing zone in accordance with an illustrative environment;

FIG. 4 is an illustration of a flight deck of an aircraft containing a swing zone and a visual feature in accordance with an illustrative environment;

FIG. 5 is another illustration of a flight deck of an aircraft containing a swing zone and a visual feature in accordance with an illustrative environment;

FIG. 6 is an illustration of a sensor system for generating image data of an area containing a swing zone in accordance with an illustrative embodiment;

FIG. 7 is an illustration of a flowchart of a process for providing an autonomous warning in accordance with an illustrative embodiment;

FIG. 8 is an illustration of a flowchart of a process for providing an autonomous warning in accordance with an illustrative embodiment;

FIG. 9 is an illustration of a flowchart of a process for providing an autonomous warning in accordance with an illustrative embodiment;

FIG. 10 is an illustration of a flowchart of a process for generating an autonomous warning in accordance with an illustrative embodiment;

FIG. 11 is an illustration of a block diagram of an overhead bin management system in accordance with an illustrative embodiment;

FIG. 12 is an illustration of a passenger cabin with an overhead bin in accordance with an illustrative embodiment;

FIG. 13 is an illustration of a flowchart of a process for providing an autonomous warning in accordance with an illustrative embodiment;

FIG. 14 is an illustration of a flowchart of a process for aircraft management in accordance with an illustrative embodiment;

FIG. 15 is an illustration of a block diagram of a data processing system in accordance with an illustrative embodiment;

FIG. 16 is an illustration of a block diagram of an aircraft manufacturing and service method in accordance with an illustrative embodiment; and

FIG. 17 is an illustration of a block diagram of an aircraft in which an illustrative embodiment may be implemented.

### DETAILED DESCRIPTION

The illustrative embodiments recognize and take into account one or more different considerations as described herein. Overhead bins should be opened or closed during different phases of flight of aircraft. For example, prior to boarding and may be desirable to have overhead bins in an open position to increase the speed and efficiency at which passengers place carry-on items in these bins and reach their seats. Additionally, overhead bin should be closed prior to certain phases of flight such as taxi-out or a final approach.

Currently, the flight crew can check to ensure that overhead bins are open or closed during the appropriate phases of flight. Further, the flight can also identify cases in which overhead bins may not be used because they do not operate properly and requirements. These types of determination can be time-consuming and sometimes inaccurate when relying on the flight crew to perform these operations.

Also, pilots can be at risk of injury during sudden decompression events onboard commercial aircraft. Air pressure differentials can result in a flight deck door rapidly opening. The sweep of a door defines a swing zone area for a door in an aircraft that may need to rapidly open in response to a decompression event.

For example, a flight deck seat may be adjusted or moved such that a portion of the flight deck seat is within the swing zone. As a result, the pilot or other crew member in the flight deck seat may be in the sweep path of the flight deck door. A sudden opening of the flight deck door can potentially cause physical injury to a pilot or other crew member sitting in the flight deck Seat that is positioned in this area that obstructs opening of the flight deck door.

Thus, it would be desirable to know whether an overhead bin is open or closed or whether a seat is positioned within a swing zone in case a decompression event occurs. Sensors such as displacement sensors can be added to overhead bins or the flight deck seats. Sensors can be added to each of the degrees of freedom to determine the overall movement of the flight deck seat. This type of sensor system can be used to determine when flight deck seats are positioned or moved to occupy the swing zone of the flight deck door.

Adding sensor systems to overhead bins or seats, however, are costly to design, install, and maintain. Also, these additional safety systems add to the weight to the aircraft.

Thus, the illustrative examples can use sensors already present in the aircraft. For example, a camera system in the aircraft can be used to detect the position of overhead bins or other objects such as seats and determine whether those seats are in swing zones for doors in the aircraft. Further, additional cameras in a camera system can be made at a much lower cost as compared to designing and implementing sensors for the flight deck seat.

In one example, an aircraft management system comprising a computer system; and a bin analyzer in the computer system. The bin analyzer performs operations. The bin analyzer receives image data from a camera system in an aircraft. The image data is for areas of the aircraft that include deployment zones for overhead bins in the aircraft. The deployment zones are physical volumes that each overhead bin moves through and occupies as the overhead bin is opened. The bin analyzer identifies at least one of an opening or a closing of the overhead bins using the image data to form overhead bin usage data. The bin analyzer stores the overhead bin usage data in a data collection. The bin analyzer analyzes the data collection to determine a number of actions to perform for the aircraft.

December actions can include, for example, indicating which overhead bins are open when they should be closed or overhead bins that are closed when they should be opened. Further, the actions can also include determining boarding and deporting procedures for passengers.

In another example, an autonomous aircraft warning system comprises a camera system in an aircraft; a swing zone in the flight deck; a computer system; and an object detector. The swing zone in the flight deck is defined by a sweep path within the flight deck for a flight deck door. The object detector is located in the computer system. The object detector forms operations. For example, the object detector receives image data from the camera system, wherein the image data is for the flight deck of the aircraft that includes the swing zone. The object detector determines whether an object is in the swing zone using the image data. The object detector generates an autonomous warning in response to the object being in the swing zone.

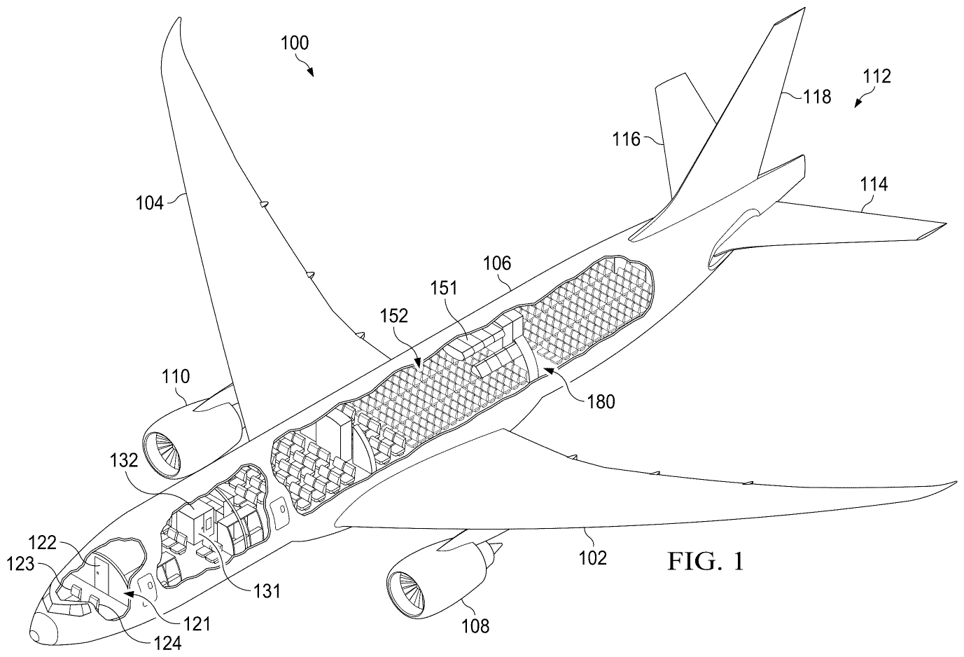

With reference now to the figures, and in particular, with reference to FIG. 1, an illustration of a cutaway view of an aircraft is depicted in accordance with an illustrative embodiment. In this illustrative example, commercial airplane 100 has wing 102 and wing 104 attached to body 106. Commercial airplane 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

As depicted, cutaways are present in this view of commercial airplane 100 to enable viewing interior portions of commercial airplane 100. For example, flight deck 121 can be seen in commercial airplane 100. In this view of flight deck 121, flight deck door 122 is a location where a pilot, copilot, and other crew members can enter or exit flight deck 121. Also seen in this view are flight deck seat 123 and flight deck seat 124 used by a copilot and pilot, respectively.

In the different illustrative examples, an autonomous flight deck warning system can be implemented to generate a warning when the flight deck seat, such as flight deck seat 124, is in a position that obstructs opening the flight deck door 122. For example, flight deck seat 124 may be moved or leaned back such that flight deck seat 124 obstructs at least one of opening or closing of flight deck door 122.

The phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

In this example, the detection of the obstruction of flight deck door 122 can be made using image data generated by one or more cameras in the camera system for interior 180 of commercial airplane 100. These images are processed to determine whether flight deck seat 124 obstructs a swing zone for flight deck door 122. A swing zone is defined by a sweep path that flight deck door 122 makes as flight deck door 122 is moved to open or close flight deck door 122.

This warning can be provided such that flight deck seat 124 can be moved to a position that does not obstruct the opening of flight deck door 122. This warning reduces undesired results in the event that a decompression event occurs resulting in flight deck door 122 swinging open while an object obstructs movement of flight deck door 122. Contact with this obstruction may be made by flight deck door 122 as it swings open. In this case, undesired effects may occur if the object is a pilot in flight deck seat 124.

In another illustrative example, the autonomous flight deck door monitoring system can be extended to function as a general door warning system. With this example, warnings can also be provided for other doors within interior 180 of commercial airplane 100. These warnings can be generated when other doors within interior 180 of commercial airplane 100 are obstructed from at least one of opening or closing by one or more objects. The objects can be selected from at least one of a seat, a passenger, a cart, or other object. For example, the warning can be generated for door 131 of lavatory 132.

In this example, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

In yet another illustrative example, the camera system for interior 180 of commercial airplane 100 can also be used to gather usage data for overhead bins 151 within the passenger cabin 152. For example, the camera system can generate image data for at least one of the opening and closing of overhead bins 151. This camera system can also detect whether overhead bins remain open or closed. This image data can be used to determine the usage of overhead bins 151 as well as a pattern of usage in loading and unloading carry-on luggage and other objects from overhead bins 151. With this data, maintenance of overhead bins, passenger boarding procedures, passenger deboarding procedures, and other processes relating to the use of overhead bins can be managed and adjusted.

The illustrations of commercial airplane 100 and interior 180 are provided as an illustration of one manner in which commercial airplane 100 can be implemented. Further, other components also are present but not shown because of the cutaways made to view interior 180 of commercial airplane 100. For example, commercial airplane 100 has additional overhead bins in addition to overhead bins 151. These other overhead bins are not shown to avoid obscuring the view of other components within passenger cabin 152. For example, other components that can be seen more clearly without these other overhead bins are rows of passenger seats as well as aisles and other areas.

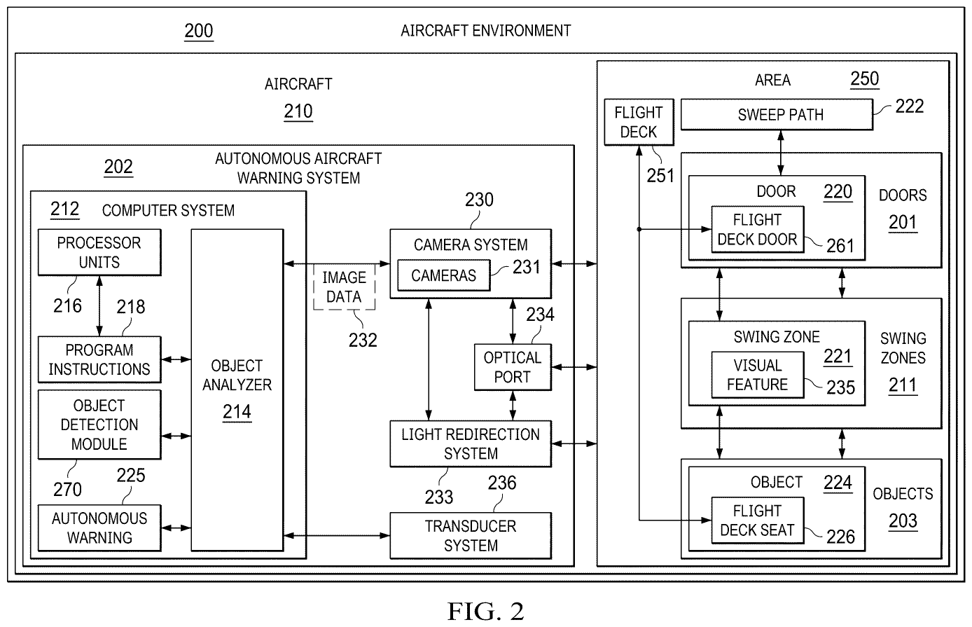

With reference now to FIG. 2, an illustration of a block diagram of an aircraft environment is depicted in accordance with an illustrative embodiment. In this illustrative example, aircraft environment 200 includes components that can be implemented in commercial airplane 100 in FIG. 1.

In this illustrative example, autonomous aircraft warning system 202 is used with aircraft 210 to automatically provide warnings of when doors 201 within aircraft 210 are obstructed by objects 203. Commercial airplane 100 is an example of an implementation of an autonomous aircraft warning system 202. Aircraft 210 can be selected from a group comprising a commercial airplane, a cargo airplane, a rotor aircraft, a tilt wing aircraft, a vertical takeoff and landing aircraft, a rotorcraft, an unmanned aerial vehicle, a drone, an artificial intelligence controlled drone, an electric vertical takeoff and landing vehicle, a personal air vehicle, a glider, and other types of aircraft that can fly in the atmosphere.

In this illustrative example, doors 201 can be obstructed when objects 203 are within swing zones 211 of doors 201. For example, door 220 in doors 201 has swing zone 221 in swing zones 211. Swing zone 221 is defined by sweep path 222 of door 220. Sweep path 222 is the path door 220 moves on when opening or closing. This movement of door 220 moves through an area or volume that is swing zone 221.

In this example, object 224 in objects 203 obstructs door 220 when door 220 is within swing zone 221 for door 220. Object 224 can be selected from a group such as a seat, a flight deck seat, a pilot seat, a person, and other physical objects that may be found within the interior of aircraft 210.

In this illustrative example, autonomous aircraft warning system 202 in aircraft 210 can monitor swing zones 211 to determine whether obstructions such as objects 203 are present within swing zones 211 and provide autonomous warning 225 when obstructions are detected in one of swing zones 211. Autonomous aircraft warning system 202 comprises camera system 230, computer system 212, and object analyzer 214.

Camera system 230 generates image data 232 using a number of cameras 231 located within the interior of aircraft 210. This image data is selected from at least one of individual images or a video stream.

In some illustrative examples, other components in autonomous aircraft warning system 202 can be present in addition to camera system 230 to monitor swing zones 211 and area 250. For example, the system can also include light redirection system 233, optical port 234, and other suitable components that can aid camera system 230 to monitor area 250.

For example, light redirection system 233 can reflect light from swing zone 221 to camera system 230 such that the light received by camera system 230 matches an angle at which the light is received by light redirection system 233 to provide a clear image of the swing zone. Light redirection system 233 can include optical components selected from at least one of a mirror, a concave mirror, or a prism, or other suitable optical components that redirect light.

Optical port 234 can enable directing light from one portion of area 250 to another portion of area 250 through a structure such as a wall or door. For example, a camera may be present in the passenger area but not in flight deck 251. With this example, optical port 234 can be designed and located such that light for swing zone 221 is received by camera system 230 through optical port 234 in a structure separating flight deck 251 from another portion of aircraft 210. This light may be directed directly to the camera in camera system 230 or reflected using light redirection system 233.

Object analyzer 214 can be implemented in software, hardware, firmware or a combination thereof. When software is used, the operations performed by object analyzer 214 can be implemented in program instructions configured to run on hardware, such as a processor unit. When firmware is used, the operations performed by object analyzer 214 can be implemented in program instructions and data and stored in persistent memory to run on a processor unit. When hardware is employed, the hardware can include circuits that operate to perform the operations in object analyzer 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operate a computer.

When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In one illustrative example, one or more technical solutions are present that overcome a technical problem with objects within a swing zone of a door in an aircraft. As a result, one or more technical solutions may provide a technical effect providing warnings to avoid a door hitting an object.

Computer system 212 can be configured to perform at least one of the steps, operations, or actions described in the different illustrative examples using software, hardware, firmware or a combination thereof. As a result, computer system 212 operates as a special purpose computer system in which object analyzer 214 in computer system 212 enables generating autonomous warnings in response to detecting objects 203 in swing zones 211. In particular, object analyzer 214 transforms computer system 212 into a special purpose computer system as compared to currently available general computer systems that do not have object analyzer 214.

In this illustrative example, object analyzer 214 performs a number of different operations to monitor swing zones 211 in aircraft 210. For example, object analyzer 214 receives image data 232 from camera system 230. In this example, image data 232 is for area 250 of aircraft 210 that includes swing zone 221 defined by sweep path 222 of door 220 in aircraft 210.

Object analyzer 214 determines whether object 224 is in swing zone 221 using image data 232. In this example, object 224 is within swing zone 221 when at least a portion of object 224 is within swing zone 221. In other words, all of object 224 does not need to be fully within swing zone 221 in these examples.

In the illustrative example, object analyzer 214 performs this analysis by using or implementing a number of different types of processes for software components. For example, object analyzer 214 can use object detection module 270 to determine whether object 224 is located in swing zone 221 using image data 232.

This object detection module can include at least one of a machine learning model, a convolutional neural network (CNN), a vision model, a segmentation model, a transformer-based vision model, or other suitable models that have been trained or designed to detect and localize objects.

Further in this illustrative example, assistance can be provided in detecting object 224 within swing zone 221 by including visual feature 235 in swing zone 221. This visual feature can be selected to make detecting objects 203 within swing zone 221 easier. For example, object 224 within the swing zone obstructs at least a portion of the visual feature. In this illustrative example, visual feature 235 can be selected from at least one of a pattern, a label, a symbol, a color cue, a contour outline for the swing zone, or other type of feature or indicator increases the ability to detect object 224 within swing zone 221.

Object analyzer 214 generates autonomous warning 225 in response to object 224 being within swing zone 221. This warning is generated in a manner to catch the attention of crewmembers such as a pilot, a copilot, a flight engineer, a flight attendant, or other crewmembers that may be present on aircraft 210.

Object analyzer 214 can generate autonomous warning 225 using transducer system 236 in aircraft 210. With transducer system 236, object analyzer 214 generates autonomous warning 225 by activating transducer system 236 in response to object 224 being within swing zone 221.

This type of warning can be useful for different events that may occur with respect to aircraft 210. In one example, area 250 can be flight deck 251 in aircraft 210, door 220 is flight deck door 261, and object 224 is flight deck seat 226. With this example, generating autonomous warning 225 can be useful in the event of a decompression event. In response to being activated to generate autonomous warning 225 by object analyzer 214, transducer system 236 performs at least one of generating an acoustic signal, generating a graphical indicator, sending a text message, emitting a scent, or other suitable action.

With this type of event, flight deck door 261 can swing open quickly in response to this event. This autonomous warning can warn a crewmember, such as a pilot, to move or readjust the position flight deck seat 226 such that flight deck seat 226 is no longer within swing zone 221. This type of adjustment may be useful when aircraft 210 is in a phase of flight in which a decompression event can occur.

This type of warning can also be useful in other types of events such as during food service. An autonomous warning of a cart in the swing zone of a door can be generated to alert a person who is on the other side of the door and cannot see the cart to avoid opening the door when the cart is present.

In the illustrative example, the use of object analyzer 214 in computer system 212 integrates processes into a practical application for providing autonomous warnings and responsive objects being within an undesired zone in aircraft. In other words, object analyzer 214 in computer system 212 is directed to a practical application of processes integrated into object analyzer 214 in computer system 212 that performs operations to detect objects in a swing zone. The detection of the object enables a practical application of generating an autonomous warning that an object is within the swing zone of a door. This autonomous warning can then be used in a practical application to move the object to avoid collision with the door in the event that the door is opened. This warning can be useful when a decompression event occurs causing the door to open quickly.

The illustration of aircraft environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, autonomous warning 225 can take a number of different forms other than those illustrated above. In one example, in generating autonomous warning 225, object analyzer 214 generates a first autonomous warning in response to object 224 in swing zone 221 being flight deck seat 226. With this example, object analyzer 214 generates a second autonomous warning in response to object 224 in swing zone 221 being a person.

As another example, object detection module 270 is shown as a separate component from object analyzer 214. With this example, object analyzer 214 uses object detection module 270. In other examples, object detection module 270 can be implemented as part of object analyzer 214.

In yet another illustrative example, object analyzer 214 can be located outside of aircraft 210 in another location such as a ground station or airline center. With this example, image data 232 can be sent to object analyzer 214 at the remote location for analysis. In yet another illustrative example, object analyzer 214 can be a distributed component in which some components are located within aircraft 210 while other components are located in another location remote to aircraft 210.

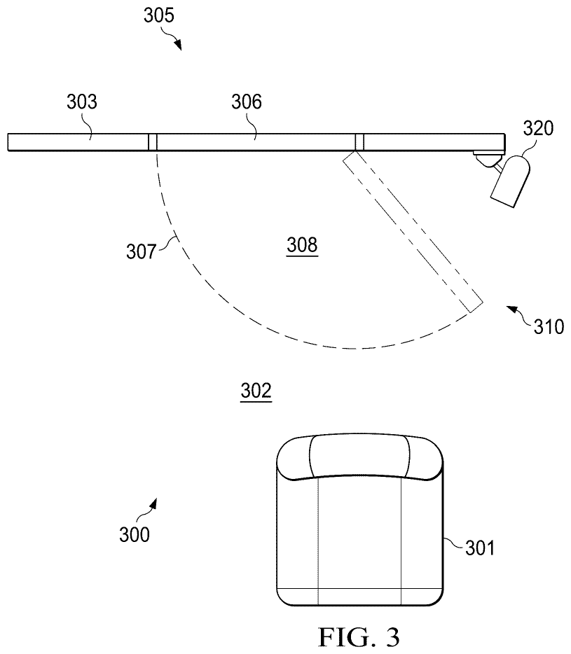

With reference now to FIG. 3, an illustration of a flight deck of an aircraft containing a swing zone is depicted in accordance with an illustrative environment. In this example, a portion of flight deck 300 is shown. Flight deck 300 is an example of flight deck 251 in FIG. 2.

In this example, flight deck seat 301 in flight deck 300 is an example of flight deck seat 226 in FIG. 2. This flight deck 300 sits on floor 302 in flight deck 300 and can be occupied by a crewmember such as a pilot or copilot. Wall 303 separates flight deck 300 from the passenger cabin 305. Flight deck door 306 enables entry and exit from flight deck 300.

In this example, flight deck door 306 can open and close by moving through sweep path 307. This sweep path defines an area referred to as swing zone 308. Camera 320 is an example of a camera in camera system 230 in FIG. 2. As depicted, this camera is attached to wall 303 and generates image data for area 310 including swing zone 308.

In this illustrative example, floor 302, wall 303, flight deck door 306, and flight deck seat 301 are patterns in the image data generated by camera 320 that can be analyzed to determine whether flight deck seat 301 or some other object is within swing zone 308.

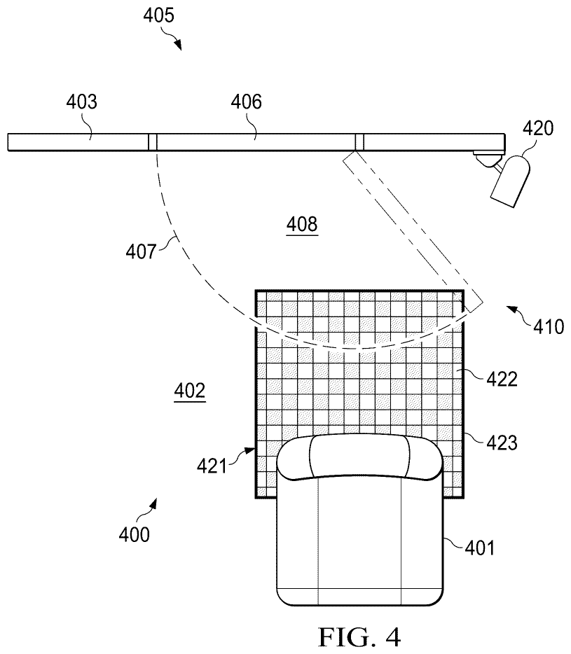

Next in FIG. 4, an illustration of a flight deck of an aircraft containing a swing zone and a visual feature is depicted in accordance with an illustrative environment. In this example, a portion of flight deck 400 is shown. Flight deck 400 is an example of flight deck 251 in FIG. 2.

Flight deck seat 401 in flight deck 400 is an example of flight deck seat 226 in FIG. 2. This flight deck seat sits on floor 402 in flight deck 400. Wall 403 separates flight deck 400 from passenger cabin 405. Flight deck door 406 enables entry and exit from flight deck 400.

In this example, flight deck door 406 has sweep path 407. This sweep path defines an area referred to as swing zone 408. Camera 420 is an example of a camera in camera system 230 in FIG. 2. As depicted, this camera is attached to wall 403 and generates image data for area 410 including swing zone 408.

In this example, visual feature 421 is located on floor 402. Visual feature 421 comprises a checkered pattern 422 with outline 423. In this example, visual feature 421 is within swing zone 408. Visual feature 421 is within swing zone 408 with a portion of checkered pattern 422 and outline 423 being within swing zone 408. In other words, all of visual feature 421 does not need to be within swing zone 408. In this example, a portion of flight deck seat 401 is located within visual feature 421. In some examples, flight deck seat 401 does not need to be within visual feature 421.

Visual feature 421 provides additional patterning in the image data generated by camera 420 or analysis in determining whether flight deck seat 401 is within swing zone 408. In this example, flight deck seat 401 is not positioned where the seat is located within swing zone 408.

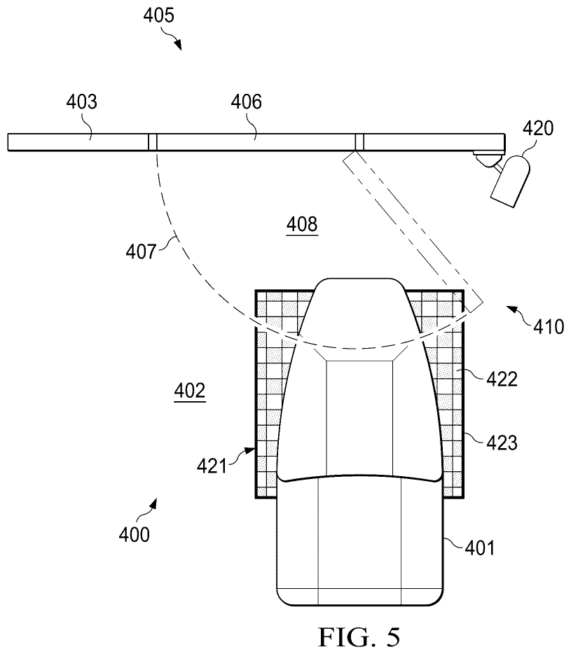

Turning to FIG. 5, another illustration of a flight deck of an aircraft containing a swing zone and a visual feature is depicted in accordance with an illustrative environment. In the illustrative examples, the same reference numeral may be used in more than one figure. This reuse of a reference numeral in different figures represents the same element in the different figures.

In this example, flight deck seat 401 has been repositioned. This repositioning of flight deck seat 401 results in flight deck seat 401 being within swing zone 408.

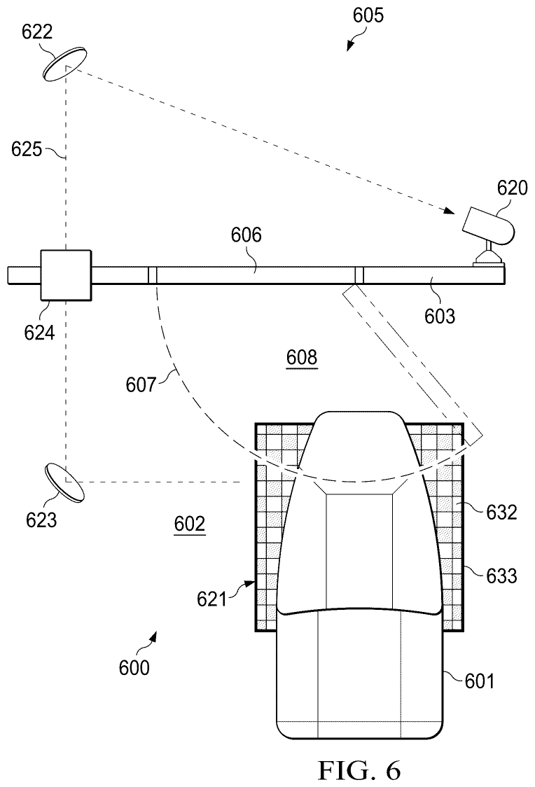

With reference next to FIG. 6, an illustration of a sensor system for generating image data of an area containing a swing zone is depicted in accordance with an illustrative embodiment. In this example, a portion of flight deck 600 is shown. Flight deck 600 is an example of flight deck 251 in FIG. 2.

Flight deck seat 601 in flight deck 600 is an example of flight deck seat 226 in FIG. 2. This flight deck seat sits on floor 602 in flight deck 600. Wall 603 separates flight deck 600 from passenger cabin 605. Flight deck door 606 enables movement into and out of flight deck 600.

In this example, flight deck door 606 has sweep path 607. This sweep path defines an area referred to as swing zone 608. In this example, visual feature 621 is located on floor 602. Visual feature 621 comprises checkered pattern 632 with outline 633.

As depicted, camera 620 is attached to wall 603 and generates image data. However, camera 620 on the side of passenger cabin 605 can have a direct view of swing zone 608 in flight deck 600. With this example, mirror 622, mirror 623, and optical port 624 are components in a light redirection system that can be used to provide light 625 from flight deck 600 including swing zone 608. In this example, mirror 622 is located in passenger cabin 605 and mirror 623 is located in flight deck 600. Optical port 624 is located in wall 603.

The arrangement and positioning of these components is such that light 625 is reflected by mirror 623 through optical port 624. This light is then reflected by mirror 622 to camera 620. Thus, these components can provide camera 620 a view of flight deck 600 that includes swing zone 608, enabling monitoring swing zone 608 for intrusion of objects such as flight deck seat 601.

The illustration of flight decks in FIGS. 3-6 have been provided as an example of one implementation for an area that can be monitored by an autonomous aircraft warning system. This illustration is not meant to limit the manner in which the different illustrative examples can be implemented. For example, monitoring can be performed for other areas such as in the passenger cabin where doors for a galley, a closet, a lavatory, or other area can be present. Further, the illustrative examples describe the swing zones as areas in two dimensions. In other examples, the swing zone can be a three-dimensional volume.

In yet another example, the monitoring of the swing zone in the flight deck can be performed for other objects in addition to the flight deck seats. For example, other objects can be detected including a cart, a crew member, or other object.

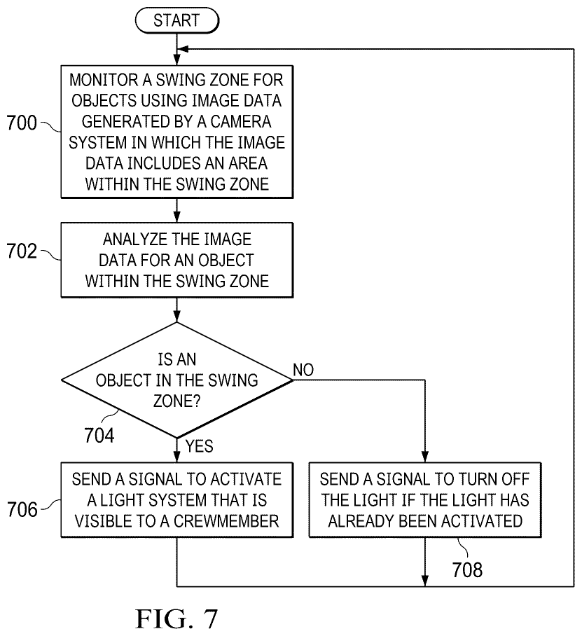

Turning next to FIG. 7, an illustration of a flowchart of a process for providing an autonomous warning is depicted in accordance with an illustrative embodiment. The process in FIG. 7 can be implemented in hardware, software, or both. When implemented in software, the process can take the form of program instructions that are run by one of more processor units located in one or more hardware devices in one or more computer systems. For example, the process can be implemented in object analyzer 214 in computer system 212 in FIG. 2.

The process monitors a swing zone for objects using image data generated by a camera system in which the image data includes an area within the swing zone (operation 700). In this example, monitoring can include generating image data and can be at least one of individual images or a video stream.

The process analyzes the image data for an object within the swing zone (operation 702). In operation 702, the analysis can be made using a machine learning model, a visual analysis system, or other suitable components that can detect objects within the swing zone.

A determination is made as to whether an object is in the swing zone (operation 704). If an object is in the swing zone, a signal is sent to activate a light system that is visible to a crewmember (operation 706).

This crew member can be, for example, a pilot, a copilot, or other crew member. The process then returns to operation 700.

Turning back to operation 704, if an object is not detected within the swing zone, the process sends a signal to turn off the light if the light has already been activated (operation 708). The process then returns to operation 700.

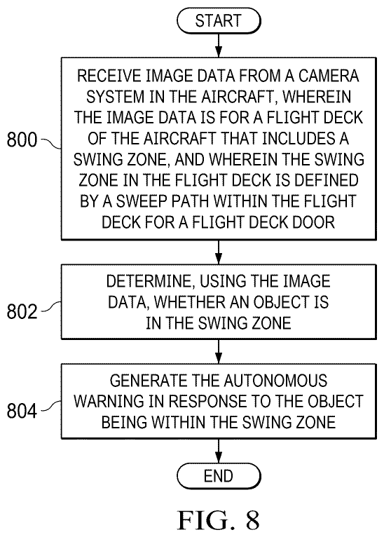

Turning next to FIG. 8, an illustration of a flowchart of a process for providing an autonomous warning is depicted in accordance with an illustrative embodiment. The process in FIG. 8 can be implemented in hardware, software, or both. When implemented in software, the process can take the form of program instructions that are run by one of more processor units located in one or more hardware devices in one or more computer systems. For example, the process can be implemented in object analyzer 214 in computer system 212 in FIG. 2.

The process receives image data from a camera system in the aircraft, wherein the image data is for a flight deck of the aircraft that includes a swing zone, and wherein the swing zone in the flight deck is defined by a sweep path within the flight deck for a flight deck door (operation 800). The process determines, using the image data, whether an object is in the swing zone (operation 802).

The process generates the autonomous warning in response to the object being within the swing zone (operation 804). The process terminates thereafter.

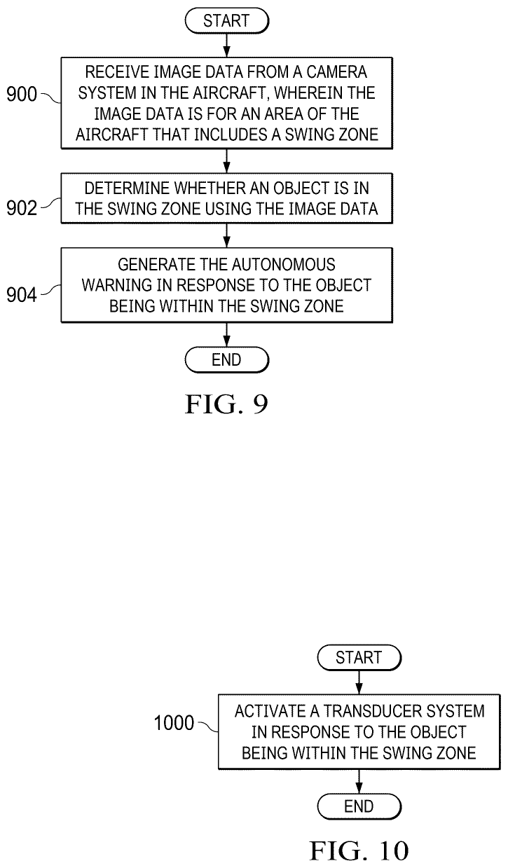

Turning next to FIG. 9, an illustration of a flowchart of a process for providing an autonomous warning is depicted in accordance with an illustrative embodiment. The process in FIG. 9 can be implemented in hardware, software, or both. When implemented in software, the process can take the form of program instructions that are run by one of more processor units located in one or more hardware devices in one or more computer systems. For example, the process can be implemented in object analyzer 214 in computer system 212 in FIG. 2.

The process receives image data from a camera system in the aircraft, wherein the image data is for an area of the aircraft that includes a swing zone (operation 900). The process determines whether an object is in the swing zone using the image data (operation 902).

The process generates the autonomous warning in response to the object being within the swing zone (operation 904). The process terminates thereafter.

Next in FIG. 10, an illustration of a flowchart of a process for generating an autonomous warning is depicted in accordance with an illustrative embodiment. This operation is an example of an implementation for operation 804 in FIG. 9.

The process activates a transducer system in response to the object being within the swing zone (operation 1000). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

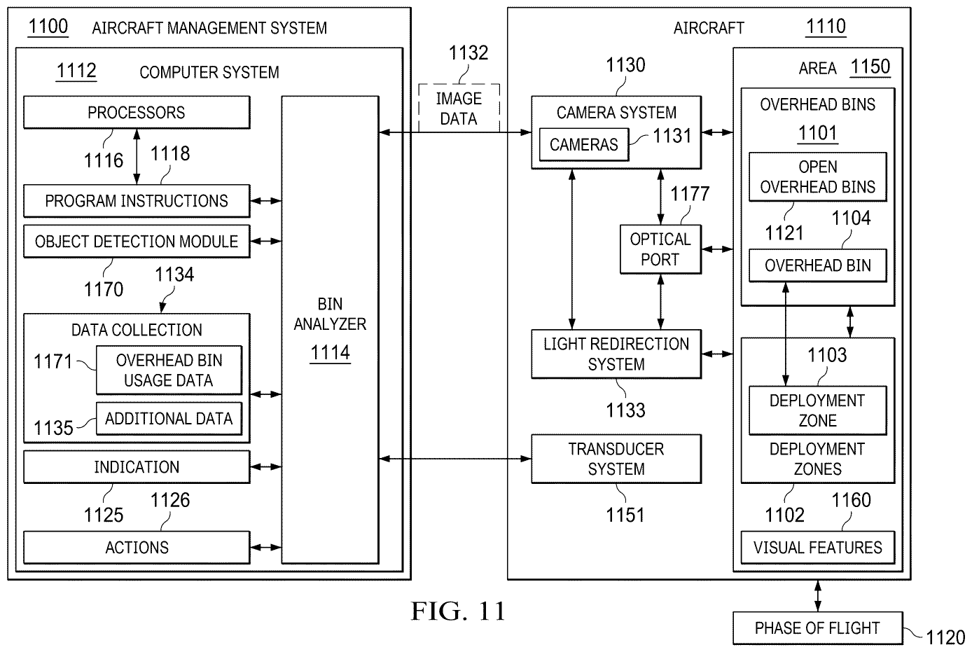

Turning now to FIG. 11, an illustration of a block diagram of an overhead bin management system is depicted in accordance with an illustrative embodiment. In this illustrative example, aircraft management system 1100 can operate to monitor usage of overhead bins 1101 in aircraft 1110. The data collected from monitoring usage can be used to perform a number of different operations for aircraft 1110 as well as other aircraft. In this example, commercial airplane 100 in FIG. 1 is an example of aircraft 1110. Aircraft 1110 can be any type of aircraft that carries passengers and has overhead bins.

In this illustrative example, aircraft management system 1100 comprises computer system 1112 and bin analyzer 1114 in computer system 1112.

Bin analyzer 1114 can be implemented in software, hardware, firmware or a combination thereof. When software is used, the operations performed by bin analyzer 1114 can be implemented in program instructions configured to run on hardware, such as a processor unit. When firmware is used, the operations performed by bin analyzer 1114 can be implemented in program instructions and data and stored in persistent memory to run on a processor unit. When hardware is employed, the hardware can include circuits that operate to perform the operations in bin analyzer 1114. In one example, bin analyzer 1114 can be implemented using program instructions 1118 that are run by a number of processors 1116 in computer system 1112.

In this illustrative example, monitoring can be performed using camera system 1130 in aircraft 1110. In this example, camera system 1130 generates image data 1132 using a number of cameras 1131. This image data can be at least one of individual images or a video stream.

With this example, deployment zones 1102 are present in aircraft 1110. For example, deployment zone 1103 is defined by a path on which overhead bin 1104 moves as overhead bin 1104 is moved to open or close.

Bin analyzer 1114 receives image data 1132 from camera system 1130. In this example, image data 1132 is for area 1150 of aircraft 1110 that includes deployment zones 1102. Bin analyzer 1114 determines whether a number of open overhead bins 1121 are present in deployment zones 1102 using the image data 1132.

Object analyzer 1114 can use object detection module 1170 to determine whether overhead bin 1104 is located in deployment swing zone 1103 using image data 1132. An overhead bin can be an open overhead bin if the overhead bin is partially or fully open.

In one example, additional components are present to aid in generating image data 1132 of deployment zones 1102 in area 1150. For example, light redirection system 1133 and optical port 1177 are present within aircraft 1110.

For example, light redirection system 1133 is configured to reflect light from a number of the deployment zones 1102 in which the light is redirected to camera system 1130 such that an angle of the light received by camera system 1130 matches the angle at which the light is received by light redirection system 1133 to provide a clear image of a number of deployment zones 1102. Light redirection system 1133 can include at least one of a mirror, a concave mirror, a prism, or other suitable redirection device.

In another example, with optical port 1177, light from a number of deployment zones 1102 is received by camera system 1130 through optical port 1177 in a structure separating one area of aircraft 1110 from another area of the aircraft 1110.

Also, a number of visual features 1160 can be located in deployment zones 1102. With this example, an overhead bin in an open position obstructs at least a portion of the number of visual features 1160. The number of visual features 1160 is selected from at least one of a pattern, a label, a symbol, a color cue, a contour outline for the deployment zone, or other type of visual feature.

Further in this example, bin analyzer 1114 can identify at least one of opening or closing of overhead bins 1101 using image data 1132 to form overhead bin usage data 1171. Image data 1132 can be selected from at least one of individual images or a video stream.

Bin analyzer 1114 can store overhead bin usage data 1171 in data collection 1134. This data collection can be at least one of a database, a spreadsheet, files in a folder, and other types of data structures and organizations.

In this example, bin analyzer 1114 can analyze data collection 1134 to determine a number of actions 1126 to perform for aircraft 1110. In this illustrative example, data collection 1134 can include additional data 1135 for overhead bin usage for other flights selected from at least one of aircraft 1110 or other aircraft.

In one example, a number of actions 1126 involves bin analyzer 1114 generating an indication 1125 of the number of open overhead bins 1121 in response to the number of open overhead bins 1121 being open during phase of flight 1120 in which the overhead bins are to be closed. In another example, this indication can be generated by bin analyzer 1114 during phase of flight 1120 in which overhead bins 1101 should be open but a number of overhead bins 1101 are closed.

The result of this process of generating indication 1125 is a practical application in which the flight crew can ensure that any open overhead bins are closed. In this example, phase of flight 1120 can be during a phase during which it is important to have overhead bins 1101 open or closed. For example, phase of flight 1120 can be a taxi-out or a final approach. In the taxi-out phase, flight cabin secure checks are performed including making sure overhead bins 1101 are closed. In the final approach phase, overhead bins 1101 also need to be checked and closed as part of performing a cabin secure check.

As another example, all of overhead bins 1101 can be open prior to boarding aircraft 1110 in a preboarding status for aircraft 1110. In this case, the opening of overhead bins 1101 can be part of a preboarding procedure for this phase.

In one example, transducer system 1151 is present in aircraft 1110. Indication 1125 can be generated using transducer system 1151, which is configured to perform at least one of generating an acoustic signal, generating a graphical indicator, sending a text message, emitting a scent, or other type of indication.

Thus, with indication 1125, crew members make sure that overhead bins 1101 are opened or closed as part of a procedure for a particular phase of flight. In this manner, indication 1125 provides for a practical application in opening and closing bins as part of a procedure for aircraft 1110.

In another illustrative example, bin analyzer 1114 can analyze data collection 1134 to identify at least one of a maintenance, a boarding procedure, or a deboarding procedure for aircraft 1110. For example, the number of actions 1126 can include maintenance of a number of the overhead bins 1101. In another example, the number of actions 1126 can be creating a boarding procedure for aircraft 1110 that increases efficiencies of at least one of boarding passengers or overhead bin usage. As another example, the number of actions 1126 can be creating a deboarding procedure for aircraft 1110 that increases efficiencies in deboarding passengers in which the deboarding procedure takes into account how overhead bins 1101 are emptied.

Further, data collection 1134 can include overhead bin usage data 1171 for aircraft 1110 and other aircraft from randomized boarding and deboarding. This data and data collection 1134 can be analyzed using a machine learning model to identify patterns for determining boarding and deboarding procedures. These patterns can change based on aircraft model, a variant of a model, time of day, holiday, and other factors.

The illustration of aircraft management system 1100 in FIG. 11 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

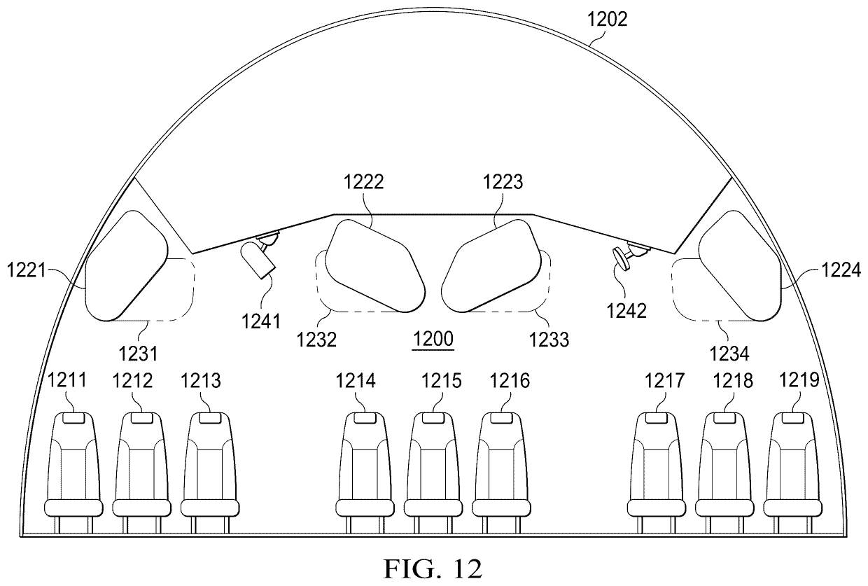

With reference next to FIG. 12, an illustration of a passenger cabin with overhead bins is depicted in accordance with an illustrative embodiment. In this illustrative example, a cross-sectional view of passenger cabin 1200 and aircraft 1202 is shown.

As depicted, passenger seat 1211, passenger seat 1212, passenger seat 1213, passenger seat 1214, passenger seat 1215, passenger seat 1216, passenger seat 1217, passenger seat 1218, and passenger seat 1219 are shown in this view of passenger cabin 1200.

Further, overhead bin 1221, overhead bin 1222, overhead bin 1223, and overhead bin 1224 are visible in this view. In this example, these bins are in the closed position.

As depicted, overhead bin 1221 has deployment zone 1231 and overhead bin 1222 has deployment zone 1232. Overhead bin 1223 has deployment zone 1233, and overhead bin 1224 has deployment zone 1234. When the overhead bins are open, these overhead bins extend into their corresponding deployment zones. As depicted in this example, these deployment zones are illustrated in two dimensions but the actual deployment zones for these overhead bins are volumes.

In this example, camera 1241 and reflector 1242 are present within passenger cabin 1200. Camera 1241 can generate image data for passenger cabin 1200 including deployment zone 1231 and deployment zone 1232. Deployment zone 1233 and deployment zone 1234 are not visible to camera 1241. Reflector 1242 is configured to reflect light from these deployment zones to camera 1241. Thus, with camera 1241 and reflector 1242, all four deployment zones can be monitored. In this manner, camera 1241 can generate image data for these deployment zones and send that image data to a bin analyzer for analysis and storage. For example, the bin analyzer can indicate when open overhead bins are present. This indication can be made during a phase of flight when the overhead bin should be closed. In another example, the indication can be enabled during the phase of flight when the overhead bins should be open but are in a closed position. Data on the opening and closing of overhead bins can be saved and analyzed to determine whether different patterns for passenger boarding and passenger deboarding may be made more efficient.

The illustration of aircraft 1202 with overhead bins is one example of monitoring overhead bins in an aircraft. This illustration is not meant to limit the manner in which other illustrative examples can be implemented. For example, a camera can be used in place of or in addition to reflector 1242 to provide monitoring for all of the deployment sentence. In other illustrative examples, other numbers of bins can be present. For example, two overhead bins can be present in a cross-sectional view rather than the four overhead bins in this illustrative example.

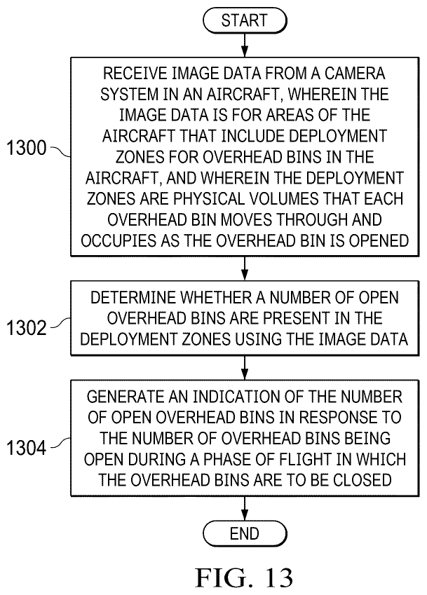

Turning next to FIG. 13, an illustration of a flowchart of a process for providing an autonomous warning is depicted in accordance with an illustrative embodiment. The process in FIG. 13 can be implemented in hardware, software, or both. When implemented in software, the process can take the form of program instructions that are run by one of more processor units located in one or more hardware devices in one or more computer systems. For example, the process can be implemented in bin analyzer 1114 in computer system 1112 in FIG. 11.

The process receives image data from a camera system in an aircraft, wherein the image data is for areas of the aircraft that include deployment zones for overhead bins in the aircraft, and wherein the deployment zones are physical volumes that each overhead bin moves through and occupies as the overhead bin is opened (operation 1300). The process determines whether a number of open overhead bins are present in the deployment zones using the image data (operation 1302).

The process generates an indication of the number of open overhead bins in response to the number of overhead bins being open during a phase of flight in which the overhead bins are to be closed (operation 1304). The process terminates thereafter.

In these examples, similar indications can be made when overhead bins are closed that should be in an open position. For example, during the pre-boarding phase of flight, it may be desirable to have overhead bins in an open position to increase the ease at which passengers can place items into overhead bins for storage.

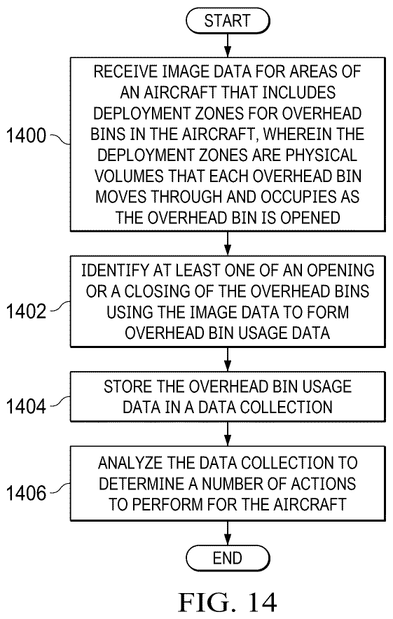

Turning next to FIG. 14, an illustration of a flowchart of a process for aircraft management is depicted in accordance with an illustrative embodiment. The process in FIG. 14 can be implemented in hardware, software, or both. When implemented in software, the process can take the form of program instructions that are run by one of more processor units located in one or more hardware devices in one or more computer systems. For example, the process can be implemented in bin analyzer 1114 in computer system 1112 in FIG. 11.

The process receives image data for areas of an aircraft that includes deployment zones for overhead bins in the aircraft, wherein the deployment zones are physical volumes that each overhead bin moves through and occupies as the overhead bin is opened (operation 1400). The process identifies at least one of an opening or a closing of the overhead bins using the image data to form overhead bin usage data (operation 1402).

The process stores the overhead bin usage data in a data collection (operation 1404). The process analyzes the data collection to determine a number of actions to perform for the aircraft (operation 1406). The process terminates thereafter.

Thus, these different processes enable a practical application of performing actions with respect to the aircraft and passenger boarding and deboarding. For example, a number of actions can be a maintenance of a number of the overhead bins. The analysis can indicate that an overhead bin may need maintenance because the bin has not opened or closed over some amount of time. This non-use indicates that the bin is not operating correctly and thus not used by passengers.

In another example, the number of actions can include creating a boarding procedure for the aircraft that increases efficiencies of at least one of boarding passengers or overhead bin usage. In yet another example, the number of actions can include creating a deboarding procedure for the aircraft that increases efficiencies in deboarding passengers in which the deboarding procedure takes into account how overhead bins are emptied. Thus, this analysis of data collected on overhead bin usage can be used in a practical application to perform actions with respect to at least one of the overhead bins, boarding an aircraft, or deboarding an aircraft.

Some features of the illustrative examples are described in the following clauses. These clauses are examples of features and are not intended to limit other illustrative examples.

### Clause 1

An autonomous aircraft warning system comprising:
a camera system in an aircraft;
a swing zone in a flight deck defined by a sweep path within the flight deck for a flight deck door;
a computer system; and
an object detector in the computer system, wherein the object detector performs operations comprising:
   receiving image data from the camera system, wherein the image data is for the flight deck of the aircraft that includes the swing zone;
   determining, using the image data, whether an object is in the swing zone; and
   generating an autonomous warning in response to the object being within the swing zone.

### Clause 2

The autonomous aircraft warning system of clause 1, wherein generating the autonomous warning comprises:
generating a first autonomous warning in response to the object in the swing zone being a flight deck seat; and
generating a second autonomous warning in response to the object in the swing zone being a person.

### Clause 3

An autonomous aircraft warning system comprising:
a camera system in an aircraft;
a computer system; and
an object detector in the computer system, wherein the object detector performs operations comprising:
   receiving image data from the camera system, wherein the image data is for an area of the aircraft that includes a swing zone defined by a sweep path of a door in the aircraft;
   determining, using the image data, whether an object is in the swing zone; and
   generating an autonomous warning in response to the object being within the swing zone.

### Clause 4

The autonomous aircraft warning system of clause 3 further comprising:
a light redirection system configured to reflect light from the swing zone to the camera system such that the light received by the camera system matches an angle at which the light is received by the light redirection system to provide a clear image of the swing zone, wherein the light redirection system can be at least one of a mirror or a prism.

### Clause 5

The autonomous aircraft warning system of clause 4, wherein the light redirection system is selected from at least one of a mirror, a concave mirror, or a prism.

### Clause 6

The autonomous aircraft warning system of clause 3, wherein the swing zone is in a flight deck of the aircraft and further comprising:
an optical port, wherein light from the swing zone is received by the camera system through the optical port in a structure separating the flight deck from another portion of the aircraft.

### Clause 7

The autonomous aircraft warning system of clause 3 further comprising:
a transducer system in the aircraft,
wherein said generating the autonomous warning in response to the object being within the swing zone comprises:
   activating the transducer system in response to the object being within the swing zone.

### Clause 8

The autonomous aircraft warning system of clause 7, wherein the transducer system performs at least one of generating an acoustic signal, generating a graphical indicator, sending a text message, or emitting a scent.

### Clause 9

The autonomous aicraft warning system of clause 3, further comprising:
a visual feature located within the swing zone.

### Clause 10

The autonomous aircraft warning system of clause 9, wherein the visual feature is configured such that an object in the swing zone obstructs at least a portion of the visual feature.

### Clause 11

The autonomous aircraft warning system of clause 9, wherein the visual feature is selected from at least one of a pattern, a label, a symbol, a color cue, or a contour outline for the swing zone.

### Clause 12

The autonomous aircraft warning system of clause 3, wherein the image data is selected from at least one of individual images or a video stream.

### Clause 13

The autonomous aircraft warning system of clause 3, wherein the object is selected from the group consisting of a seat, a flight deck seat, a pilot seat, and a person.

### Clause 14

A method for providing an autonomous warning in an aircraft, the method comprising:
receiving image data from a camera system in the aircraft, wherein the image data is for a flight deck of the aircraft that includes a swing zone, and wherein the swing zone in the flight deck is defined by a sweep path within the flight deck for a flight deck door;
determining whether an object is in the swing zone using the image data; and
generating the autonomous warning in response to the object being within the swing zone.

### Clause 15

A method for providing an autonomous warning in an aircraft, the method comprising:
receiving image data from a camera system in the aircraft, wherein the image data is for an area of the aircraft that includes a swing zone;
determining, using the image data, whether an object is in the swing zone using the image data; and generating the autonomous warning in response to the object being within the swing zone.

### Clause 16

The method of claim 15, wherein a light redirection system reflects light from the swing zone to the camera system such that the light received by the camera system matches an angle at which the light is received by the light redirection system to provide a clear image of the swing zone.

### Clause 17

The method of claim 15, wherein the swing zone is in a flight deck of the aircraft and wherein light from the swing zone is received by the camera system through an optical port in a structure separating the flight deck from another portion of the aircraft.

### Clause 18

The method of clause 15, wherein said generating the autonomous warning comprises:
activating a transducer system in response to the object being within the swing zone.

### Clause 19

The method of claim 18, wherein the transducer system performs at least one of generating an acoustic signal, generating a graphical indicator, sending a text message, or emitting a scent.

### Clause 20

The method of claim 15 wherein a visual feature located within the swing zone from which the camera system generates image data.

### Clause 21

The method of claim 20, wherein the object in the swing zone obstructs at least a portion of the visual feature.

### Clause 22

The method of clause 20, wherein the visual feature is selected from at least one of a pattern, a label, a symbol, a color cue, or a contour outline for the swing zone.

### Clause 23

The method of clause 15, wherein the image data is selected from at least one of individual images or a video stream.

### Clause 24

The method of clause 15, wherein the object is selected from the group consisting of a seat, a flight deck seat, a pilot seat, and a person.

### Clause 25

A computer program product for providing an autonomous warning in an aircraft, the computer program product comprising:
a set of one or more computer-readable storage media;
program instructions stored on the set of one or more storage media to perform operations comprising:
receiving image data from a camera system in the aircraft, wherein the image data is for a flight deck of the aircraft that includes a swing zone, and wherein the swing zone in the flight deck is defined by a sweep path within the flight deck for a flight deck door;
determining, using the image data, whether an object is in the swing zone; and
generating the autonomous warning alert in response to the object being within the swing zone.

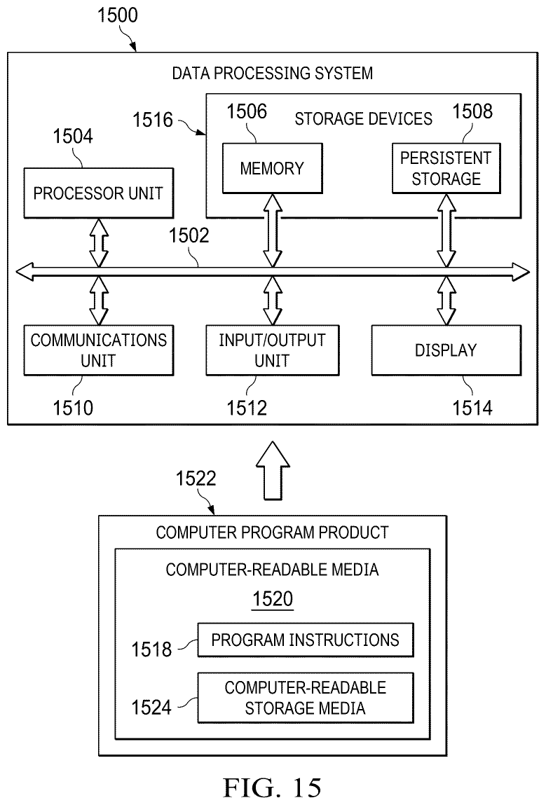

Turning now to FIG. 15, an illustration of a block diagram of a data processing system is depicted in accordance with an illustrative embodiment. Data processing system 1500 can be used to implement computer system 212 in FIG. 2 and computer system 1112 in FIG. 11. In this illustrative example, data processing system 1500 includes communications framework 1502, which provides communications between processor unit 1504, memory 1506, persistent storage 1508, communications unit 1510, input/output (I/O) unit 1512, and display 1514. In this example, communications framework 1502 takes the form of a bus system.

Processor unit 1504 serves to execute instructions for software that can be loaded into memory 1506. Processor unit 1504 includes one or more processors. For example, processor unit 1504 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1504 can be implemented using one or more heterogeneous processor systems in which a main processor is present with secondary processors on a single chip. As another illustrative example, processor unit 1504 can be a symmetric multi-processor system containing multiple processors of the same type on a single chip.

Memory 1506 and persistent storage 1508 are examples of storage devices 1516. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1516 may also be referred to as computer-readable storage devices in these illustrative examples. Memory 1506, in these examples, can be, for example, a random-access memory or any other suitable volatile or non-volatile storage device. Persistent storage 1508 may take various forms, depending on the particular implementation.

For example, persistent storage 1508 may contain one or more components or devices. For example, persistent storage 1508 can be a hard drive, a solid-state drive (SSD), a flash memory, a rewritable optical disk, a rewritable magnetic tape, or some combination of the above. The media used by persistent storage 1508 also can be removable. For example, a removable hard drive can be used for persistent storage 1508.

Communications unit 1510, in these illustrative examples, provides for communications with other data processing systems or devices. In these illustrative examples, communications unit 1510 is a network interface card.

Input/output unit 1512 allows for input and output of data with other devices that can be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs can be located in storage devices 1516, which are in communication with processor unit 1504 through communications framework 1502. The processes of the different embodiments can be performed by processor unit 1504 using computer-implemented instructions, which may be located in a memory, such as memory 1506.

These instructions are referred to as program instructions, computer usable program instructions, or computer-readable program instructions that can be read and executed by a processor in processor unit 1504. The program instructions in the different embodiments can be embodied on different physical or computer-readable storage media, such as memory 1506 or persistent storage 1508.

Program instructions 1518 are located in a functional form on computer-readable media 1520 that is Selectively removable and can be loaded onto or transferred to data processing system 1500 for execution by processor unit 1504. Program instructions 1518 and computer-readable media 1520 form computer program product 1522 in these illustrative examples. In the illustrative example, computer-readable media 1520 is computer-readable storage media 1524.

Computer-readable storage media 1524 is a physical or tangible storage device used to store program instructions 1518 rather than a medium that propagates or transmits program instructions 1518. Computer-readable storage media 1524 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer-readable storage media 1524, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 1518 can be transferred to data processing system 1500 using a computer-readable signal media. The computer-readable signal media are signals and can be, for example, a propagated data signal containing program instructions 1518. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1520” can be singular or plural. For example, program instructions 1518 can be located in computer-readable media 1520 in the form of a single storage device or system. In another example, program instructions 1518 can be located in computer-readable media 1520 that is distributed in multiple data processing systems. In other words, some instructions in program instructions 1518 can be located in one data processing system while other instructions in program instructions 1518 can be located in one data processing system. For example, a portion of program instructions 1518 can be located in computer-readable media 1520 in a server computer while another portion of program instructions 1518 can be located in computer-readable media 1520 located in a set of client computers.

The different components illustrated for data processing system 1500 are not meant to provide architectural limitations to the manner in which different embodiments can be implemented. In some illustrative examples, one or more of the components may be incorporated in or otherwise form a portion of, another component. For example, memory 1506, or portions thereof, may be incorporated in processor unit 1504 in some illustrative examples. The different illustrative embodiments can be implemented in a data processing system including components in addition to or in place of those illustrated for data processing system 1500. Other components shown in FIG. 15 can be varied from the illustrative examples shown. The different embodiments can be implemented using any hardware device or system capable of running program instructions 1518.

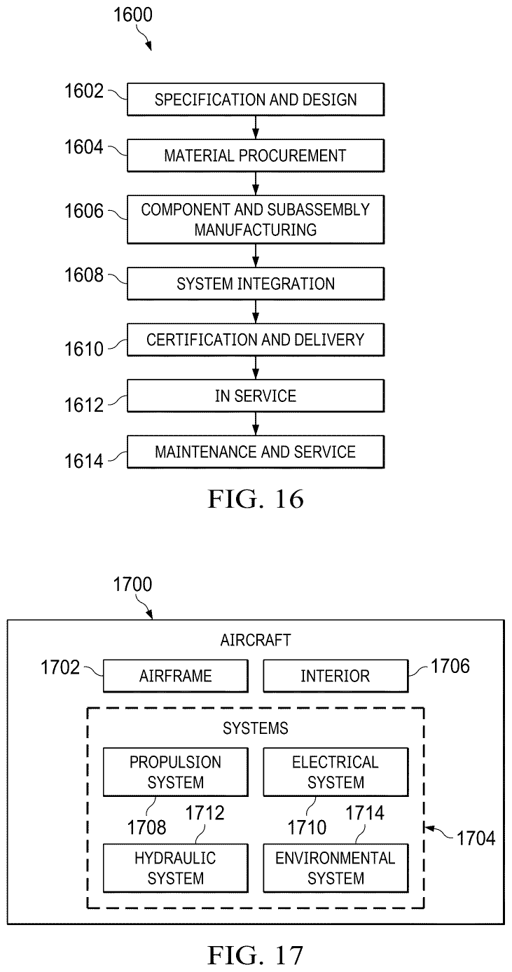

Illustrative embodiments of the disclosure may be described in the context of aircraft manufacturing and service method 1600 as shown in FIG. 16 and aircraft 1700 as shown in FIG. 17. Turning first to FIG. 16, an illustration of a block diagram of an aircraft manufacturing and service method is depicted in accordance with an illustrative embodiment. During pre-production, aircraft manufacturing and service method 1600 may include specification and design 1602 of aircraft 1700 in FIG. 17 and material procurement 1604.

During production, component and subassembly manufacturing 1606 and system integration 1608 of aircraft 1700 in FIG. 17 takes place. Thereafter, aircraft 1700 in FIG. 17 can go through certification and delivery 1610 in order to be placed in service 1612. While in service 1612 by a customer, aircraft 1700 in FIG. 17 is scheduled for routine maintenance and service 1614, which may include modification, reconfiguration, refurbishment, and other maintenance or service.

Each of the processes of aircraft manufacturing and service method 1600 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 17, an illustration of a block diagram of an aircraft is depicted in which an illustrative embodiment may be implemented. In this example, aircraft 1700 is produced by aircraft manufacturing and service method 1600 in FIG. 16 and may include airframe 1702 with plurality of systems 1704 and interior 1706. Examples of systems 1704 include one or more of propulsion system 1708, electrical system 1710, hydraulic system 1712, and environmental system 1714. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1600 in FIG. 16.

In one illustrative example, components or subassemblies produced in component and subassembly manufacturing 1606 in FIG. 16 can be fabricated or manufactured in a manner similar to components or subassemblies produced while aircraft 1700 is in service 1612 in FIG. 16. As yet another example, one or more apparatus embodiments, method embodiments, or a combination thereof can be utilized during production stages, such as component and subassembly manufacturing 1606 and system integration 1608 in FIG. 16. One or more apparatus embodiments, method embodiments, or a combination thereof may be utilized while aircraft 1700 is in service 1612, during maintenance and service 1614 in FIG. 16, or both. The use of a number of the different illustrative embodiments may substantially expedite the assembly of aircraft 1700, reduce the cost of aircraft 1700, or both expedite the assembly of aircraft 1700 and reduce the cost of aircraft 1700.

For example, an autonomous aircraft warning system 202 in FIG. 2 can be implemented during component and subassembly manufacturing 1606. In another example, the system can be implemented in aircraft 1700 during maintenance and service 1614 in which at least one of modification, reconfiguration, refurbishment, and other maintenance or service are performed. In a similar fashion, aircraft management system 1100 can also be implemented during one of these stages. Further, these two types of systems can operate during in service 1612 of aircraft 1700.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. An aircraft management system comprising:
a camera system in an aircraft;
deployment zones for overhead bins in the aircraft, wherein the deployment zones are physical volumes that each overhead bin moves through and occupies as the overhead bin is opened;
a computer system,
an overhead bin analyzer in the computer system, wherein the overhead bin analyzer performs operations comprising:
receiving image data from the camera system, wherein the image data is for areas of the aircraft that include the deployment zones;
determining whether a number of open overhead bins are present in the deployment zones using the image data;
generating an indication of the number of open overhead bins in response to the number of open overhead bins being open during a phase of flight in which the overhead bins are to be closed; and
a light redirection system configured to reflect light from a number of the deployment zones in which the light is redirected to the camera system such that an angle of the light received by the camera system matches the angle at which the light is received by the light redirection system to provide a clear image of a number of the deployment zones.

2. The aircraft management system of claim 1, wherein the operations further comprise:
identifying at least one of opening or closing of the overhead bins using the image data to form overhead bin usage data; and
storing the overhead bin usage data in a data collection.

3. The aircraft management system of claim 2, wherein:
the data collection includes additional data for overhead bin usage for other flights
selected from one of at least one of the aircraft or other aircraft; and
the overhead bin analyzer further performs operations comprising:
analyzing the data collection to identify at least one of a maintenance, a boarding procedure, or a deboarding procedure for the aircraft.

4. (canceled)

5. The aircraft management system of claim 1, further comprising:
an optical port, wherein light from a number of deployment zones is received by the camera system through the optical port in a structure separating one area of the aircraft from another area of the aircraft.

6. The aircraft management system of claim 1, further comprising:
a number of visual features located in the deployment zones, wherein an overhead bin in an open position obstructs at least a portion of the number of visual features.

7. An aircraft management system comprising:
a computer system;
an overhead bin analyzer in the computer system, wherein the overhead bin analyzer performs operations comprising:
receiving image data from a camera system in an aircraft, wherein the image data is for areas of the aircraft that include deployment zones for overhead bins in the aircraft, and wherein the deployment zones are physical volumes that each overhead bin moves through and occupies as the overhead bin is opened;
identifying at least one of an opening or a closing of the overhead bins using the image data to form overhead bin usage data;
storing the overhead bin usage data in a data collection;
analyzing the data collection to determine a number of actions to perform for the aircraft; and
a light redirection system configured to reflect light from a deployment zone in which the light is redirected to the camera system such that an angle of the light received by the camera system matches the angle in which the light is received by the light redirection system to provide a clear image of the deployment zone.

8. The aircraft management system of claim 7, wherein the number of actions comprises:
a maintenance of a number of the overhead bins.

9. The aircraft management system of claim 7, wherein the number of actions comprises:
creating a boarding procedure for the aircraft that increases efficiencies of at least one of boarding passengers or overhead bin usage.

10. The aircraft management system of claim 7, wherein the number of actions comprises:
creating a deboarding procedure for the aircraft that increases efficiencies in deboarding passengers in which the deboarding procedure takes into account how overhead bins are emptied.

11. The aircraft management system of claim 7, wherein the operations further comprise:
determining whether a number of open overhead bins are present in the deployment zones using the image data; and
generating an indication of the number of open overhead bins in response to the number of overhead bins being open during a phase of flight in which the overhead bins are to be closed.

12. (canceled)

13. The aircraft management system of claim 7, wherein the light redirection system is selected from at least one of a mirror, a concave mirror, or a prism.

14. The aircraft management system of claim 7, further comprising:
an optical port, wherein light from the deployment zone is received by the camera system through the optical port in a structure separating one area of the aircraft from another area of the aircraft.

15. The aircraft management system of claim 11, further comprising:
a transducer system in the aircraft, wherein said generating the indication comprises activating the transducer system.

16. The aircraft management system of claim 15, wherein the transducer system is configured to perform at least one of generating an acoustic signal, generating a graphical indicator, sending a text message, or emitting a scent.

17. The aircraft management system of claim 7, further comprising:
a number of visual features located in the deployment zone.

18. The aircraft management system of claim 17, wherein an overhead bin in an open position obstructs at least a portion of the number of visual features.

19. The aircraft management system of claim 18, wherein the number of visual features is selected from at least one of a pattern, a label, a symbol, a color cue, or a contour outline for the deployment zone.

20. The aircraft management system of claim 7, wherein the image data is selected from at least one of individual images or a video stream.

21-25. (canceled)

26. An aircraft management system comprising:
a camera system in an aircraft;
deployment zones for overhead bins in the aircraft, wherein the deployment zones are physical volumes that each overhead bin moves through and occupies as the overhead bin is opened;
a computer system;
an overhead bin analyzer in the computer system, wherein the overhead bin analyzer performs operations comprising:
receiving image data from the camera system, wherein the image data is for areas of the aircraft that include the deployment zones;
determining whether a number of open overhead bins are present in the deployment zones using the image data;
generating an indication of the number of open overhead bins in response to the number of open overhead bins being open during a phase of flight in which the overhead bins are to be closed; and
a light redirection system configured to reflect light from a number of the deployment zones in which the light is redirected to the camera system such that an angle of the light received by the camera system matches the angle at which the light is received by the light redirection system to provide a clear image of a number of the deployment zones, wherein the light redirection system is selected from at least one of a mirror, a concave mirror, or a prism, and wherein the operations further comprise:
identifying at least one of opening or closing of the overhead bins using the image data to form overhead bin usage data; and
storing the overhead bin usage data in a data collection.

27. The aircraft management system of claim 26, wherein:
the data collection includes additional data for overhead bin usage for other flights selected from one of at least one of the aircraft or other aircraft; and
the overhead bin analyzer further performs operations comprising:
analyzing the data collection to identify at least one of a maintenance, a boarding procedure, or a deboarding procedure for the aircraft.

28. The aircraft management system of claim 26, further comprising:
a transducer system in the aircraft, wherein said generating the indication comprises activating the transducer system, wherein the transducer system is configured to perform at least one of generating an acoustic signal, generating a graphical indicator, sending a text message, or emitting a scent.
